(19) United States
(12) Patent Application Publication
(10) Pub. No.: US 2010/0165610 A1
(43) Pub. Date: Jul. 1, 2010

(54) Long-Range Illuminator Using Multiple Radiation Dispersion Angles

(76) Inventor: David A Dean, Commerce Twp, MI (US)

Correspondence Address: DORT PATENT, P.C., BOX 320069, Alexandria, VA, 22320, US

(21) Appl. No.: 12/303,960

(22) PCT Filed: Jun. 7, 2007
(86) PCT No.: PCT/US07/13377

§ 371 Date: Dec. 8, 2008

Related U.S. Application Data
(60) Provisional application No. 60/811,421, filed on Jun. 7, 2006.

(51) Int. Cl. F21L 4/02; F21V 3/04; F21V 29/00; F21V 1/00

(52) U.S. Cl. 362/184; 362/311.01; 362/294; 362/235

(57) ABSTRACT

An illumination system, designed primarily for use in assist in a landing an airplane, includes a collimator that accepts radiation from a set of laser diodes, that may be at different wavelengths. The collimator directs the radiation to a diffusion screen that includes a Fourier dispersion film that results in multiple dispersion angles of the radiation, which is ideally suiting for airplane landing or other uses, such as surveillance, improved optical collection and transmission surface used in the illuminator, includes a plastic mold injection surface including staggered multiple transmission sites each with a recessed portion in which incident light is not lost during reflection towards the propagation surface.

### REFERENCE TO PRIORITY DOCUMENTS

This Application claims priority under 35 USC §119(e) to U.S. Provisional Application Ser. No. 60/811,421, entitled LASER ILLUMINATOR FOR LANDING USING MULTIPLE RADIATION DISPERSION ANGLES, filed Jun. 7, 2006, which is incorporated by reference for all purposes. This Application also claims priority under 35 USC §120, and is a continuation-in-part of co-pending U.S. application Ser. Nos. 11/675,252, filed Feb. 15, 2007 and entitled HIGHLY-EFFICIENT OPTICAL COLLECTION AND REFLECTION SURFACE(S) AND MOLDING SYSTEM FOR MANUFACTURE OF SAME and 11/682,541, filed Mar. 6, 2007 and entitled HIGHLY-EFFICIENT OPTICAL COLLECTION AND REFLECTION SURFACE(S) AND MOLDING SYSTEM FOR MANUFACTURE OF SAME.

### BACKGROUND

A significant problem with laser diode illumination systems is that the equipment needed to convert a strong laser light source into a diffuse light beam is considerable. Efforts have been made to reduce the size of the laser diode illumination systems, such as in U.S. Pat. No. 6,429,429 B1. However, the systems remain relatively large.

Laser diode illumination systems function by dispersing a single point laser light source into a diffuse light beam. This is accomplished by passing the laser light beam through various screens, such as collimators and diffusers until the tight beam of light is spread into a sufficiently broad beam. For most applications it is desirable to spread the light beam evenly, however, for some applications an uneven spreading of the beam may be desired. These principles are illustrated in U.S. Pat. No. 7,186,008, issued Mar. 6, 2007 (incorporated by reference herein) by Dean et al and assigned to the owner of the present application and US Patent Published Application 06-98423, by Dean et al (incorporated by reference herein).

By reducing the size of the illumination sources, industries such as night-vision systems can offer products that are more portable and efficient and therefore, usable. Also, current portable night vision illumination devices produce relatively low illumination levels and poor energy efficiency, which, in turn, limits night vision equipment to narrow fields of view with low resolution.

### SUMMARY

What is needed is a laser diode illumination device that is smaller and more portable, also known as having a reduced footprint, and has the capability of supplementing current vision technology implemented in the military and for civilian uses. The illumination systems should avoid Impeding illumination qualities, be available and flexible for a variety of applications, including aircraft uses and allow for efficient use of energy.

The intensity of illumination is directly related to the power of the laser diode and the efficiency of the illumination system. Laser diodes in many watt ranges, but particularly in the 2-70 watt range, may typically be used, although wattages outside this range can easily be used depending on the application. The lower the wattage that can possibly be used, the more effective the adaptability of the illumination system for use in highly-mobile applications such as aircraft, rescue, surveillance, etc. The efficiency of the illumination system depends in a large part on the quality of the parts used; however an efficiency of 65% is readily obtainable and can reach higher efficiency depending on the type and quality of various components needed by the end-user. The frequency of the illuminating light can also be varied, but in certain embodiments of the present illumination system is in the 700-1600 nm range (infrared, but even up to 2000 nm in some embodiments), and can include two diodes of differing wavelengths in a particular embodiments.

Other objects, features, and advantages in accordance with the present invention are provided particular embodiments in a portable laser diode light diffuser, a long-range illuminator that comprises a casing, where the casing is comprised of durable plastic molded or metal (in which a thermally dispersive material like aluminum is used) casing with a ventilated exterior and one or more laser diode light sources, where the one or more laser diode light source emits a concentrated beam of light at one or more predetermined wavelength. The beam of light is received directly or indirectly as a concentrated beam of light from the laser diode into a collimator lens. The collimator receives the concentrated beam of light and projects the concentrated beam of light into a plane of light and then into various configuration of multiple diffusion films disposed on one or more diffusion screens, which is capable of rotating. The diffusion screens containing the diffusion films spread the planes of light in two different “diffusion patterns” primarily at large and small angles simultaneously. However various dispersion angles for the diffusion films are also used in the invention. A flood light may be added to the long-range illuminator and also provides complementary standard illumination. The resulting field of illumination is generally between 10-70 watts in a preferred embodiment, but can go much lower or higher if the end-use dictates.

The present invention in a preferred embodiment provides for a reduced-footprint long-range illumination device, which is particularly suitable for assisting with aircraft vision uses, provides easily mounted, controlled, energy-efficient and variable illumination for use with existing vision technology. Other long-range illumination uses are also appropriate. Other embodiments of the invention are useful in illuminating in conjunction with many night-vision technologies or other applicable areas, such surveillance, search and rescue, robot vision, machine vision, etc. Laser diodes in a single or multiple wavelengths, are an excellent source of illumination for a variety of different spectrum, particularly infrared.

An embodiment of the present invention diffuses the laser diode light beam by an advanced collimation lenses at multiple angles, so that a much larger area can be thoroughly illuminated than would otherwise be possible. The spreading of the collimated light beam is then controlled by a variety of Fourier transforming film diffusers, particularly two simultaneous diffusion patterns. The qualities of the illumination field, such as eye safety and field of dispersion, can be adjusted according to the needs of the end-user.

### BRIEF DESCRIPTION OF THE DRAWINGS

The various embodiments of the invention are better under stood by reference to the following exemplary drawings, in which:

FIG. 1 illustrates a first embodiment of the long-range illumination device;

FIG. 2 illustrates the light dispersion system of the long-range Illumination device;

FIG. 3A illustrates a side view of external housing of a first embodiment of the long-range illuminator;

FIG. 3B illustrates a cut-away rear view of the long-range illuminator;

FIG. 3C illustrates a front view of an external housing of a first embodiment of the long-range illuminator;

FIG. 4A illustrates an embodiment of the long-range illuminator in an aircraft vision configuration;

FIG. 4B illustrates an close up view of the aircraft vision configuration;

FIG. 4C illustrates a second view of the aircraft vision configuration;

FIG. 5A illustrates a first state of a rotating diffusion screen in a first embodiment;

FIG. 5B illustrates a second state of a rotating diffusion screen in a first embodiment;

FIG. 5C Illustrate a third state of a rotating diffusion screen in a first embodiment;

FIG. 6 illustrates an alternate embodiment of a single laser diode illuminator;

FIG. 7A illustrates a first internal configuration of multiple wavelength diodes;

FIG. 7B illustrates a first illumination field in the multi-wavelength diode illumination system;

FIG. 7C illustrates the second internal configuration of the multiple-wavelength diode illumination system;

FIG. 7D illustrates the second illumination field in the multi-wavelength diode illumination system;

FIG. 8A illustrates a first position in an alternate embodiment providing optional eye safety compliance;

FIG. 8B illustrates a second position in the alternate embodiment in which there is no eye safety compliance;

FIG. 9A illustrates a dual diffusion plate illumination system at a first time;

FIG. 9B illustrates the dual diffusion plate illumination system at a second time;

FIG. 10A illustrates a first sample iteration of a dual diffusion plate illumination system;

FIG. 10B illustrates a second sample iteration of a dual diffusion plate illumination system;

FIG. 10C illustrates a sample radiation/illumination field in a dual diffusion plate illumination system;

FIG. 11A illustrates of a set of first sample test results for an embodiment of the invention;

FIG. 11A illustrates of a set of second sample test results for an embodiment of the invention;

FIG. 12A illustrates a estimated results in improving night vision goggles;

FIG. 12B illustrates estimated results in improving FLIR cameras.

FIG. 13 illustrates a rear view of the transmission surface of the collimator component;

FIG. 14 shows a model of the improved collimator used in the landing illuminator from a ¾ view;

FIG. 15A illustrates the side view of the components an improved collimator;

FIG. 15B illustrates the front view of the components an improved collimator used in an embodiment of a long-range illuminator;

FIG. 16A illustrates detail of principle on which an improved collimator operates;

FIG. 16B illustrates a macro view of the improved radiation transmission principle; and

FIG. 17 is a functional diagram of a “staggered” reduced-material collimator;

### DETAILED DESCRIPTION OF THE DRAWINGS

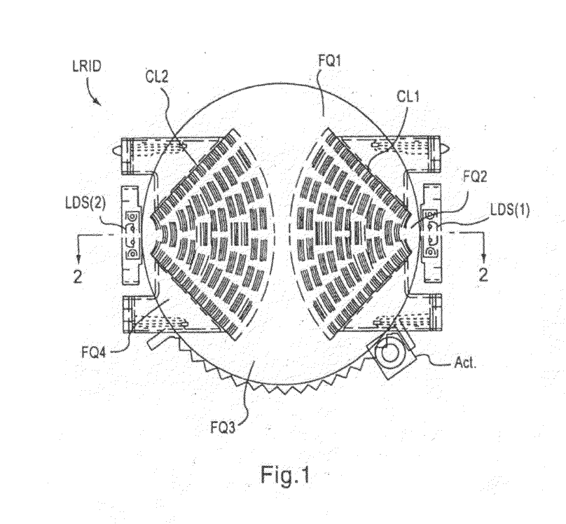

FIG. 1 illustrates the front view cut-away detail of the long-range illumination device LRID, mainly for use in aircraft vision although it is certainly applicable to other illumination needs. The illumination device LRID includes a pair of laser diodes LDS(1), LDS(2) that are coupled with a power source (not shown), which can be located externally (such as hooked to a vehicle power system) or internally to the long-range illuminator. The laser diodes LDS(1) and LDS(2) can emit the same radiation wavelength λ(s) in a first embodiment, but also may emit differing wavelengths λ(1), λ(2), in other embodiments. The emitted radiation may be directly in electromagnetic contact (direct light) or directed through a mirror (not shown) into specialized collimator lenses CL(1) and CL(2).

In a preferred embodiment, the collimator lenses CL(1) and CL(2) are a particular type in which the reflection surface is generally cut at alternating angles of approximately 45 and 135 degrees to the vertical plane. Particular electromagnetic properties and operation of the specialized collimator elements CL(1) and CL(2) is discussed below in FIGS. 13-17, below, and is also, inter alia, of which the technical subject matter of U.S. patent application Ser. No. 11/675,252 and 11/682,541, which are incorporated by reference, for all purposes.

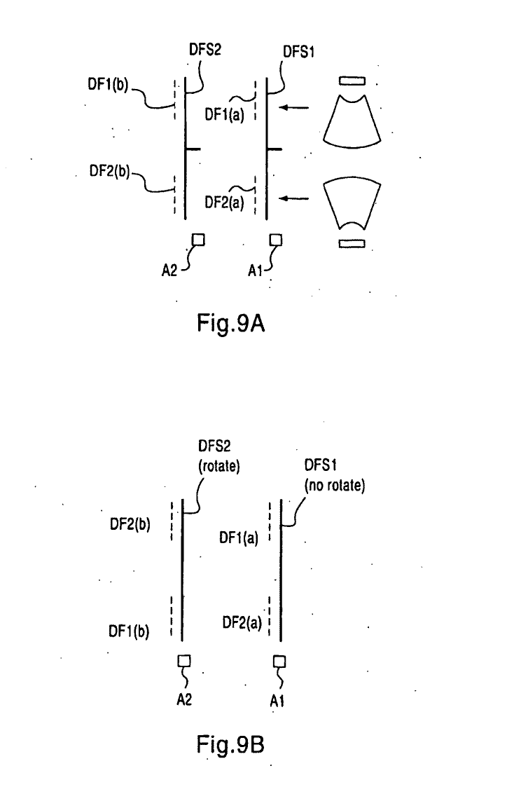

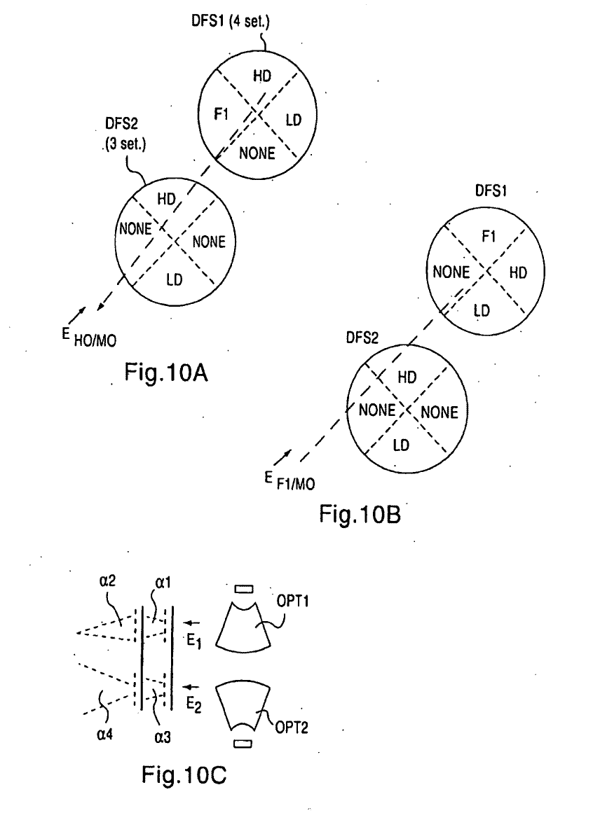

The radiation from the two collimators CL(1) and CL(2) is collected and propagated/directed in an “outward” direction to a diffusion film screen DFS, that includes at least two film “quadrants,” and in the illustration includes four roughly equal diffusion film regions or quadrants FQ1, FQ2, FQ3, FQ4. The diffusion film on the surface divided into quadrants FQ1, FQ2, FQ3, and FQ4, that allows the radiation to be dispersed into variable dispersion angles. In the first embodiment of the invention, quadrants FQ1 . . . FQ4 are used, but other embodiments of the invention are not limited to 4 regions, and can be dependent on the needs of an end-user. Although diffusion screens that are divided into quadrants FQ1 . . . FQ4 are shown in the illustrations in FIG. 1-3C, and are used in particular embodiments, the invention may implement other configurations as well, particularly in multi-diffusion screen embodiments (see FIGS. 9A-10C below). This may include, but are not limited to, evenly and unevenly divided regions, halves, thirds, quadrants, etc.

The holographic diffusing film(s), used in the embodiment shown in FIG. 1, are located on all the regions of the translucent diffusion screen DFS is generally from Physical Optics Corporation of Torrance, Calif., and the specifications of which are hereby incorporated by reference. Many of the diffusion films required in certain embodiments of the invention are generally made to custom specifications, but are not limited to such, and may not be available without providing (“off the shelf”) the specifications regarding angle dispersion to the manufacturer. These films in many embodiments will be made of polycarbonate materials, providing for a reduced weight. In general, in the embodiments shown in FIG. 1, the films included in regions FQ1 and FQ3 will have similar Fourier transform films for the dispersion of the laser radiation from the collimators, and the holographic diffusion films in regions FQ2 and FQ4 will have the same or similar Fourier transforms for the radiation dispersion.

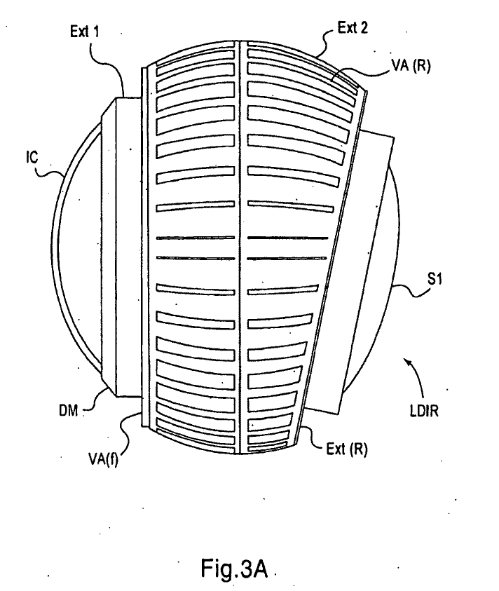

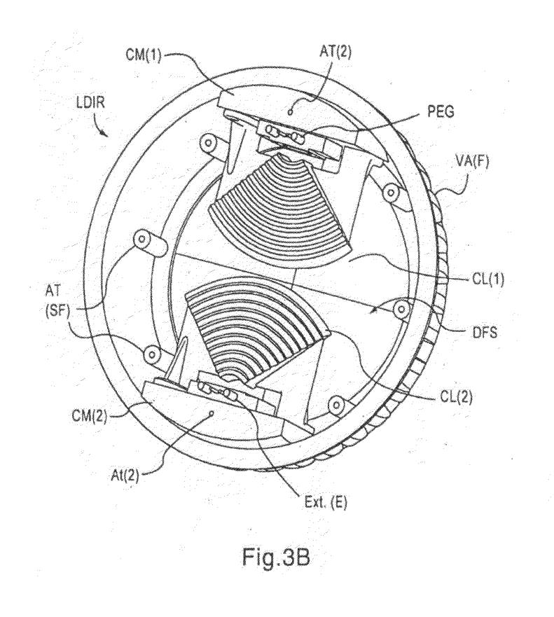

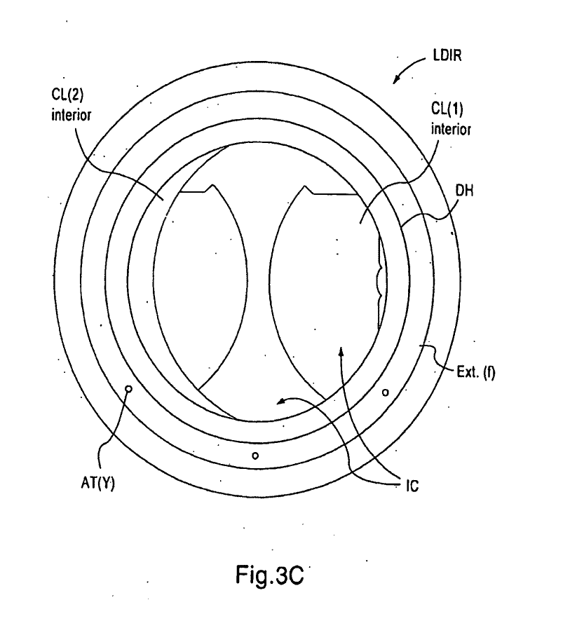

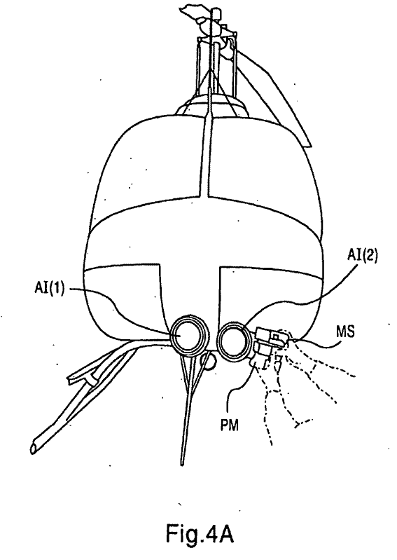

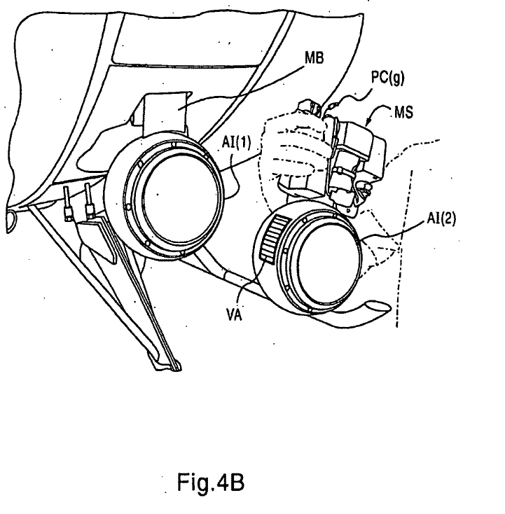

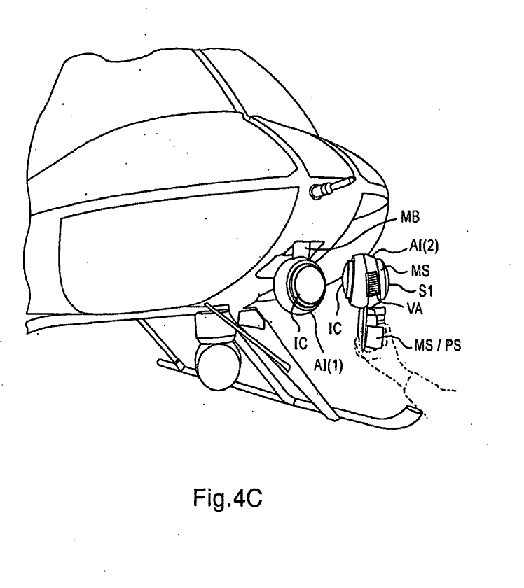

The added features of dual diodes and dual diffusing films enables maximized illumination while maintaining “Class I eye safety” at variable altitudes of flight. On the obverse side of the illuminating landing device is an optional standard 150-watt (flood) illuminator that is often desirable in addition to the infrared illumination (see index SI, FIGS. 3A-4C).

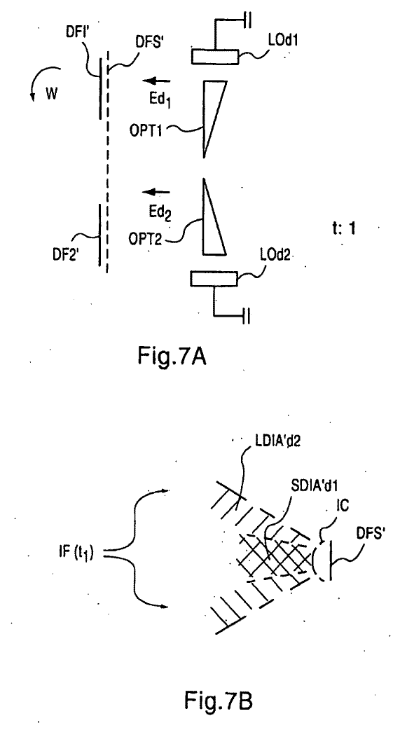

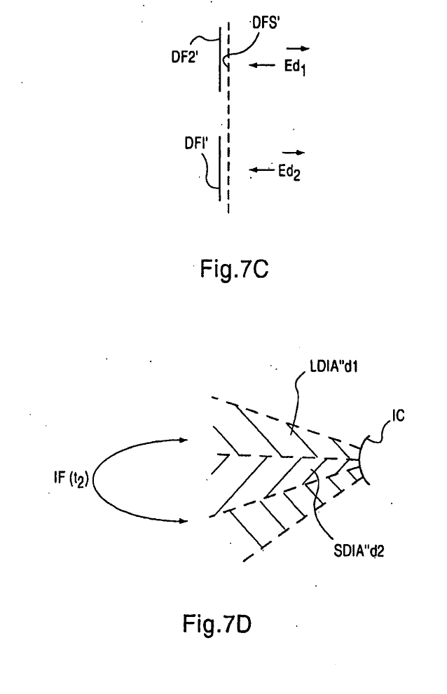

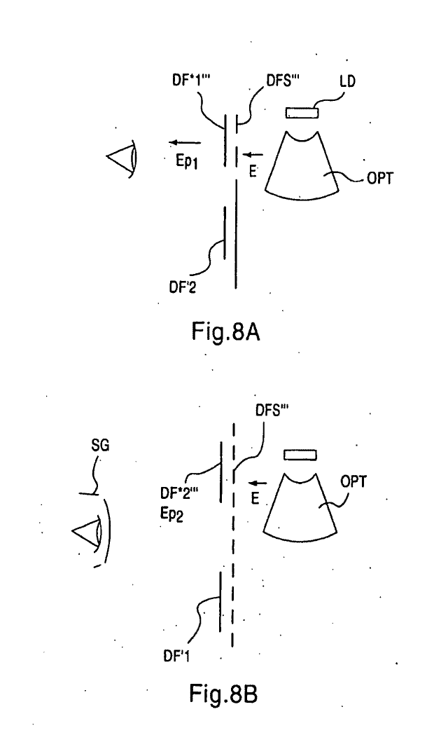

An actuator or rotating mechanism Act, is used to “rotate” the diffusion screen DFS in the embodiment shown in FIG. 1, although a rotating diffusion screen is not necessary for many embodiments of the invention. The actuator Act may be automatically, mechanically, or manually controlled, and may also include a lock (not shown) or safety feature in certain embodiments (particular embodiments that allow eye safety standards to be shut off). Embodiments of the present invention that include dual diodes allow for variable wavelengths and variable power settings that increase the adaptability and safety of the illumination system (and are discussed below at FIGS. 7A-8B) particularly when combined with the rotating diffusion screen DFS.

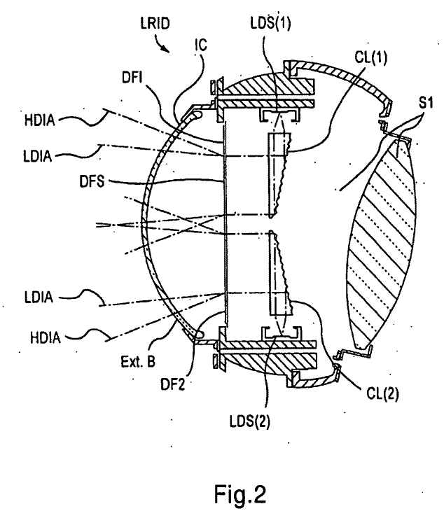

FIG. 2 shows the system of the radiation dispersion angles and additional structural features of the primary embodiment of the invention in a long-range illumination device LRID. The radiation from the diodes LDS(1) and LDS(2) (whether at the same wavelength or different wavelengths) passes into the collimators CL1 and CL2, either directly, or in alternate embodiments, through a mirror (not shown). The operation and features of the collimators is discussed extensively below, and, in particular embodiments, the collimators themselves CL1, CL2, provide improved radiation dispersion delivery to the diffusion film screen DFS, which includes the multiple types of diffusion film. The result of the four film dispersion quadrants FQ1 . . . FQ4 as shown in FIG. 2 is that there are at least two distinct dispersion illumination areas/angles, LDIA, and HDIA, which correspond to “low dispersion illumination angle/area” and “high dispersion illumination angle/area,” respectively.

As the projected planar light leaves the casing it passes through a divided Fourier transform diffusion films DF1 and DF2 disposed on the diffusion screen DFS. The diffusion films DF1, DF2 scatter the light over the respective broader areas, and generally at distinguishable illumination patterns, which are different dispersion areas in the illustration, LDIA, HDIA. One type of filter, known as a holographic diffuser serves as the diffusion films in one embodiment, and such a diffusion film, generally acts as a non-linear (generally, but not limited to Fourier transforms) and spreads the light/radiation in a each in a uniform manner or other intended pattern (depending the Fourier or other non-linear transform pattern) without changing its frequency and without large impact on the net amount of illumination for each “dispersion.” Holographic diffusers are generally in the form of a thin polycarbonate film or screen, supplied by POC™ of Torrance, Calif. The specifications regarding these holographic diffusion systems is available from POC, at their Internet site (http://www.poc.com) or from specifications available from the company: and included both “standard” (off the shelf) and “custom” solutions (discussed above) from the aforementioned company. In addition to spreading the light evenly or not, exactly how the light is spread can vary depending on the application and the needs of the end user. Essentially a wider area of illumination can be spread in exchange for illumination distance and vice versa. An exemplary range of spread would be 2-10° vertical, both up and down, and 2-10° horizontal, to both sides for a short dispersion illumination angle/area SDIA, and 10-25 degrees for a large dispersion illumination angle/area LDIA, but will vary depending of the end user needs.

Referring again to FIG. 2, after the light/radiation passes through the respective diffusion films DF1 DF2 on the (rotating) diffusion screen DFS, it generally passes through a translucent portion IC of the external housing Ext of the long-range illuminator LDIR. The long-range illuminator LDIR may also include a “standard flood” light SI in certain embodiments, which can serve to supplement the laser generated illumination.

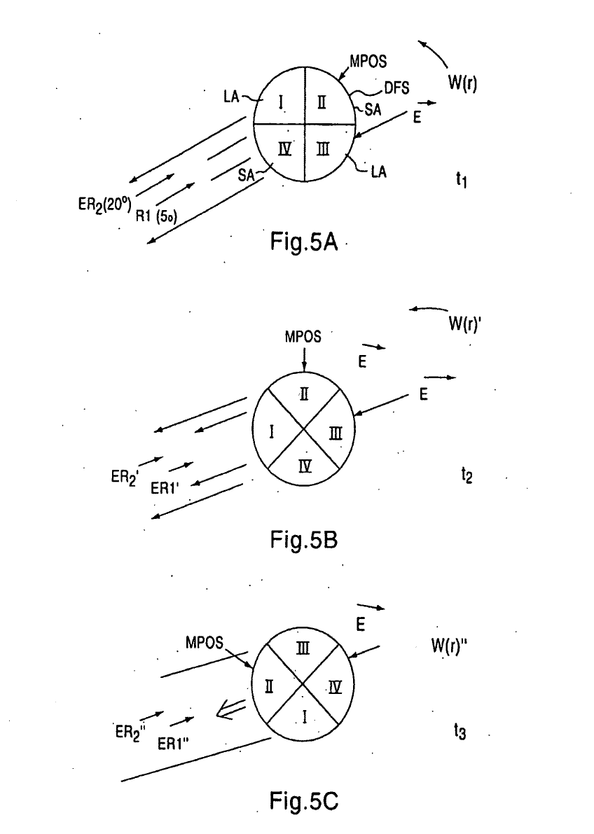

Referring now to FIGS. 5A-C, an optional feature is illustrated that further increases the flexibility of the long-range illuminator LDIR in providing radiation for landing and other surveillance scenarios, is that the diffusion film screen DFS can “rotate” such that the quadrants of the diffusion film FQ1 . . . FQ4 pass through IR radiation at intervals dictated by the rotation speed ω(R). In FIG. 5A, a rotating diffusion screen at a first time t1, the first rotation speed of the diffusion film screen is ω(r) but can subsequently vary with the end-use needs. In this particular embodiment, the rotating film screen DFS provides for mechanism for variable end-result illumination patterns. This is because the rotation varies the films which are designed and configuration with Fourier or other patterns that are implemented in the 4 quadrants. A consistent rotation speed is contemplated in many embodiments, including the aircraft illumination configurations discussed above in FIGS. 4A-C, but not required. The resulting illumination/radiation field ER2(20)R1(5) at time t1, results from radiation being propagated and transformed while passing through the rotating diffusion screen DFS and out the translucent cover (IC, not shown) into the target illumination area.

FIG. 5B illustrates a diffusion screen DFS rotating at a second rotation speed, ω(R)' at time t2, the speed of which may be the same as rotation speed in FIG. 5A. The rotation speed at time t2 may be varied, “intra-rotation” in instances requiring different lengths of illumination propagated from the various diffusion film disposed on the diffusion screen DFS. In FIG. 5B, which includes rotating quadrants I-IV, each of the quadrants with a diffusion film, including quadrants I and III with a “long angle” diffusion film LA, and quadrants II and IV with a “short angle” diffusion film SA (which now rotate at ω(r)'). The electromagnetic field_E→, usually, but not limited to one of more frequencies of infrared radiation (see FIGS. 7A-D below) from the collimators and/or optical elements (see FIGS. 1-2), passes through quadrant III, a large angle diffusion film LA. Resulting in the illumination fields ER′2ER′1 at time t2 (which is based on the interval related to the second rotation speed).

Moving from FIGS. 5B to 5C, the rotation speed ω(r)″ at a third time t3, can once again vary with illumination needs. For example in FIG. 5C, the rotation speed may be set to the same speed (w(r)) as in FIG. 5A at time t1, but need not be the same for an entire rotation or between rotations. For example, if a longer period is needed for quadrants I/III as opposed to II/IV produce the desired illumination field, the rotation speed can vary. This may be a desirable optional feature where there are two different wavelengths produced by the respective diodes LDS(1) and LDS(2). Thus, an LDIA is created for a longer period of time at 980 nm than for the 808 nm, but both are necessary for the illumination field (for example cameras may have a particular sensitivity, or longer wavelength may perform better in zero visibility conditions). Although FIGS. 5B and 5C show that the first and second dispersion angles for the radiation have changed, this need not be the case, and the diagrams are illustrative of many of the principles.

The laser diodes LDS(1) and LDS(2) may be of a variety of types, such as an Osram™ diode. In some embodiments, the light from the diode is non-collimating, but can also be divergent in particular embodiments, where divergent radiation may be a desirable alternative (for example in embodiments that do not use the collimator optical components). Typical diodes project light as a tight rectangle. A non-collimating diode projects light as an expanding rectangle. The dimensions of the rectangle will vary depending on application, as well as the internal geometries of the light diffusion unit. In particular embodiments, the wavelength of the light produced by the diode does not change by being diffused by the diffusion unit LDIR. In the embodiment illustrated in FIGS. 1 and 2, two laser diodes LDS(1), LDS(2) are used. In other embodiments, a greater plurality of laser diodes can be used in close conjunction with one another. These plurality of laser diodes may be of the same frequency, to produce a stronger projected light, or they may be of a variety of frequencies so that a diffuse light with a greater frequency range is produced.

In addition to the above, particular embodiments allow specific color effects to be accomplished. These color effects may be accomplished by another type of laser diode, or may be accomplished by flooding the unit with unit with another type of light external to the illustrated light path. For example, in the 808 nm range, the long-range illumination unit LDIR will illuminate an area with radiation that is generally invisible to the eye without conversion. However, a small amount of red spectrum visible light may also be produced. Since red lights have particular meanings in many industries, it may not be desirable to have the light diffusion unit shine red. A second visible light source can be added almost anywhere within the light diffusion unit, for instance green, to flood out the red glow, creating an 808 nm invisible light source that also appears to shine green. Of course the second light source, unless emitted from a diode and forced through the illustrated pathway, will not illuminate in the same manner as the first.

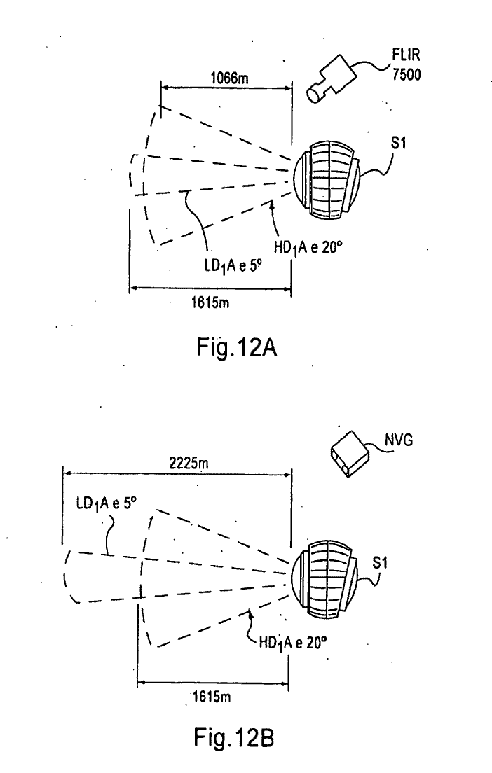

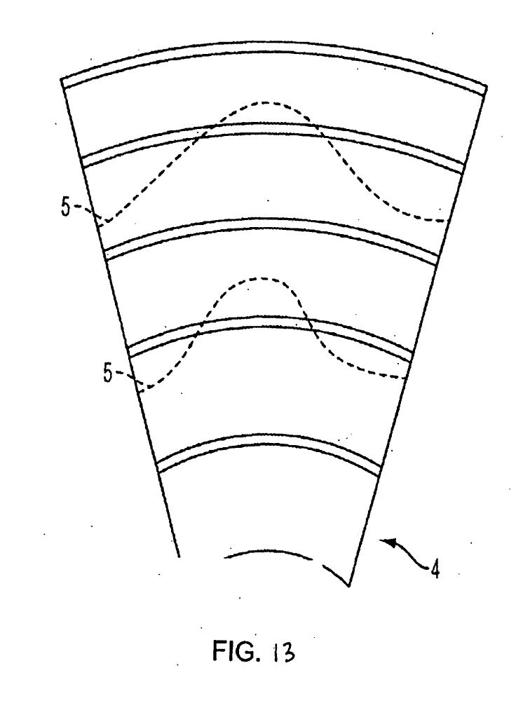

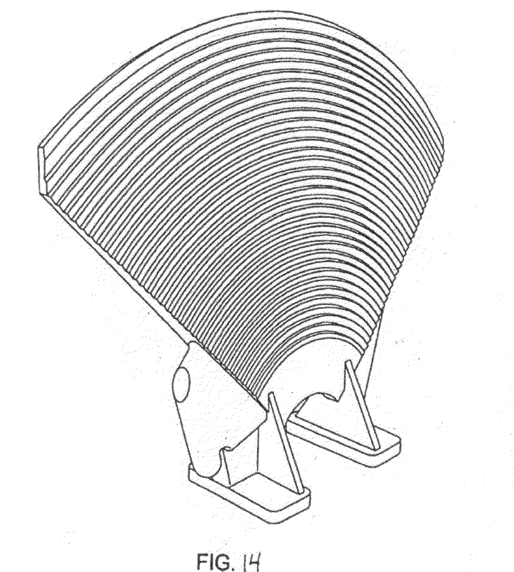

In alternate embodiments, the laser diodes LDS(1) and LDS(2) can be pulsed, so that diodes of the same frequency can produce a continuous stream of plane projected light, or at least continuous enough to the human eye or equipment monitoring the light diffuser unit. In this embodiment the pulsing of the diodes reduces their heat output and also increases the life expectancy of the diodes. It is also possible that the long-range illumination diffusion unit LDIR can function at a variety of different states, such that if a stronger light source is required multiple diodes turn on simultaneously, while a more heat/energy/life conservative mode can be used in default that pulses the diodes. Additionally, the rate of pulse between the diodes can be changes depending what is using the light diffuser as a light source. For instance, a camera outfitted with the appropriate filters and lenses for recording the illuminated area, might require more or less pulses of light to function optimally than would the human eye looking through goggles, as would certain machine vision technologies, which are briefly discussed at FIGS. 12A and 12B, discussed below.

Although, the holographic (Fourier) diffuser films DF(1)/DF(2) may reduce the overall efficiency of the illumination unit LDIR, the distribution of the radiation is optimized, the spread of the light with fewer light diffusers are preferable. However, as given in an embodiment below, sometimes additional light diffusers are added to improve the light spread so that the overall efficiency is optimized and/or the desirable non-linear transform of the light plane emanates from the system.

Referring to FIGS. 3A-C, the external features of the long-range illumination system in a preferred embodiment are shown. FIG. 3A illustrates a side view of the illuminator enclosed in a protective plastic mold injected or aluminum cast exterior housing EXT (in alternate embodiments, formed thermally conductive metal (other than aluminum mentioned above, may be used). The housing EXT covers the standard illuminator (the 150-watt flood) SI is angled slightly away from the opposite of the infrared illuminator cover IC. A seam S allows for ease of manufacture for two different illumination systems and assembly often “snap fit” form or otherwise easily attached, in preferred manufacturing embodiments including a front portion Ext(F) and a rear portion Ext(R). In the embodiment shown, a diffusion housing OH which includes the diffusion screen DFS (on which the various diffusion films are disposed) “fits” in between the housing and the illumination cover IC. A ventilation structure VA is located around the widest part of the side in the embodiment shown, allowing for additional thermal cooling. As stated above, the infrared illuminator systems may share a power supply component (not shown in FIGS. 3A-3C) with the standard illuminator SI for economy, but various configurations will depend on the end-use needs of the implementer/installer and considering the manufacturing requirements as well. As stated above, the power supply and controller in many configurations will be located exterior to the housing, such as in the aircraft illuminator configuration discussed at FIGS. 4A-C.

FIG. 3B illustrates a cutaway rear view of an embodiment of the long-range illuminator. The exterior housing IC is composed of the front portion of the housing Ext(F) which includes a ventilation configuration, in two parts, on each respective half VA(f) and VA(r) in the side. Certain attachment features are also seen in the secure fastening portions AT(sf), which are shown as female, and the male portions, which are labeled as PEG. The collimators CL(1) and CL(2) are shown as installed in the front part of the exterior EXT(F), and mounted on collimator mounts CM(1), CM(2) that extend into the “space” of the rear portion of the exterior EXT(R) (not shown) in FIG. 3B. Other attachment holes, such as AT(1), AT(2), may provide additional snap fit (particularly suitable for the plastic housing models) or likewise secure attachment, and may also provide ways to attach power and control wiring into the interior, in embodiments that require installation and do not have the power supply inside the exterior housing EXT. FIG. 3C illustrates a front view of the exterior housing EXT in which the illumination cover IC is shown in more detail.

Referring now to FIG. 4A-C, an embodiment of the long range illuminator is shown in the form of an aircraft lander illumination system. FIG. 4A illustrates two of the long-range illuminators AI(1) and AI(2) as they are installed into a typical helicopter. A mounting system MS is shown separately from the airplane landing illuminators AI(1) and AI(2). The mounting system MS shown in FIGS. 4A-C is a standard power supply, and is a “Dual Search Light Controllable” Part No. 930-500-50 made by Luminator Aircraft Products for use in some aircraft landing embodiments of the invention. Insofar as is needed to install certain embodiments of the long-range illuminator into typical aircraft, the specifications for this part number are hereby incorporated by reference. However, it is anticipated that many different types of power and control devices (mounting system MS) may be used in various embodiments of the present invention without departing from the scope and spirit of the invention. In other embodiments the power supply may be directly provided in the housing.

FIG. 4B is a close up of an embodiment of the aircraft lander/surveillance, configuration of the long-range illuminator illustrated in FIG. 4A, showing the installation pack or mounting system MS which includes a power connection and an optional camera (not shown, discussed below). A mounting bracket MB physically attaches an airplane illuminator AI(1) to the airplane. FIG. 4C illustrates the airplane lander configuration of the long-range illuminator. Other optional features not shown, include a mounting system which allows the long-range illuminator to be tilted a certain angles for optimal illumination of the illumination field.

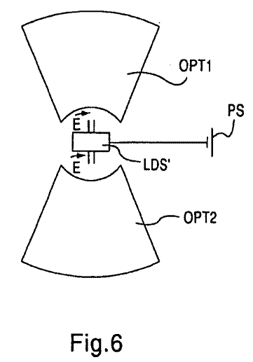

Referring now to FIG. 6 a single diode, dual collimator configuration is shown. The single laser diode LDS′ is connected to a power supply (internally to the housing or externally), and drives radiation with or without using mirror, which are not shown, in opposite directions (in either a convergent or divergent beam) towards the two optical elements in the form of optical collimators OPT1 and OPT2. The collimators operate in the same fashion as described in FIGS. 1 and 2, discussed above. The single laser diode LDS′ configuration may be desirable for some uses of the long-range illuminator, as it can save power, but the type of diode that can provide the multi-direction radiation may not be appropriate for many applications. It should be noted that the “single diode” configuration, may actually include more than one diode, but simply located as shown in FIG. 6.

Referring now to FIGS. 7A-D, particular configurations of the invention in a multi-wavelength embodiment is shown. The rotation of the diffusion plate DFS at rotation speed ω may be used for optimal illumination particular to certain conditions or the rotation speed may vary, as discussed in FIGS. 5A-C above. For example, as shown in FIGS. 7A-D the two types of diffusion films DFS1 and DFS2 disperse two different types of radiation produced by two different types of diodes LDλ1, LDλ2. The diodes, which may be in the form of variable diodes or even multiple diodes may even be in different “ranges” such that a first section is illuminated under a first type of radiation λ1, for example, in the 700-1000 nanometer range (near infrared), being dispersed by the “short angle/area” film, DF1′ simultaneously a diode that produces radiation in the 1000-1600 nm range (far infrared) being dispersed in a second section by a “long angle/area” file DF2′ such that a second section illuminated under the second type of radiation λ2. Although in many embodiments, all radiation remains between 700-1000 nm in the “near infrared” range, which can be adapted for use with many cameras for use in surveillance models.

The embodiment shown in FIG. 7A illustrates an multiple-wavelength configuration at a first time (t1) that two radiation fields, Eλ1 and Eλ2 are created by the two laser diodes, and directed by the optical elements (collimators) OPT1, OPT2, towards the rotation diffusion screen DFS′ which includes the two types of diffusion films DF1′, DF2′. FIG. 7B illustrates the resulting illumination field IF(t1) from the illumination device configuration in FIG. 7A at time T1. The first electrical field Eλ1 is diffused so that it distributes the radiation as small dispersion illumination angle field SDIA′λ1 as indicated the “checked” field in the diagram, such that the field is illuminated at the wavelength from radiation of the first laser diode. The illumination field LDIA″ λ2 is illuminated by the second wavelength (as indicated by the single slanted lines in the diagram). There also may be certain wavelength “overlap” that may be desirable from this particular configuration.

FIG. 7C illustrates the embodiment shown in FIG. 7A, now at a second time T2, such that the rotating diffusion screen DFS′ has now “switched” diffusion films with regard to the respective radiation fields Eλ1 and Eλ2 being diffused by the collimators (not shown in FIG. 7C). The resulting radiation illumination field IF(t2), as shown in FIG. 7D, is the reverse of the one shown in FIG. 7B, such that the first wavelength is dispersed into the Large dispersion illumination angle LDIA″ λ1 (shown by the checked pattern) and the second wavelength is dispersed into the short dispersion illumination angle SDIA″ λ2.

In general, various embodiments of the long-range illuminators will have class I eye safety ratings, although it may be desirable to remove eye safety requirements when certain illumination conditions are required, or in the event that a wavelength of the diode (see FIGS. 7A-D, discussed above) is no longer subject to particular eye safety requirements (such as infrared greater than 1000 nm or that is totally invisible) and further diffusion may create too much degradation of the illumination field. In general, one of the goals of many embodiments of the invention, including the airplane lander is to maintain a class I eye safety rating, so the viewing distance can be a critical consideration in constructing various embodiments. However, as shown in FIGS. 8A-B, the rotating diffusion screen DFS′″ can be configured to “balance” eye safety standards with illumination needs. In FIG. 8A, the film diffusion screen DFS′″ includes a diffusion film DF1″ that creates an illumination field Ep1 that complies with eye safety standards. However, with the diffusion screen DFS′″ rotates either manually or automatically to a position in which a second type of diffusion film DF2″ screen the radiation from the optical collimator OPT, the radiation/illumination field Ep2 does not comply with eye safety standards, and requires special eye protection (or none if at a sufficient wavelength), such as safety goggles SG. The main reason to “switch off” such safety standards is to provide extra illumination from the radiation field.

In FIGS. 9A-9B, another type of embodiment is shown in which two diffusion screens DFS1 and DFS2, which include two or more types of diffusion films, respectively (labeled as DF1(1), DF2(1), DF1(2), DF2(2),) are used to create the desired radiation field from the radiation passing through the collimators. Each of the diffusion screens DFS1 and DFS2 is rotated by a respective actuator, A1, A2, or in alternate configurations can be rotated by the same actuator (not shown).

Illumination systems can be implemented by include multiple illumination properties, such as in which safety (or other technical aspects of the illumination field, see FIGS. 8A and 8B) may be “adjusted” to include different laser (illumination) classes. For example, the diffusion film on a single quadrant may operate on the collimated radiation such that it is compliant with federal eye safety standards. Such an aspect of the invention is illustrated in FIGS. 9A-10B, in which the diffusion films, or alternately, layers of diffusion films can create the illumination/radiation fields with the desired qualities, such as eye safety and high dispersion angle, etc.

Referring now to FIG. 10A-C, a dual film embodiment of the invention is shown which the diffusion screen DFS1 has 4 settings and the second diffusion screen DFS2 has three settings, creating 12 radiation field setting. In the second table below, if each rotating film, DFS1′, DFS2′ platform has 4 quadrants, there are 16 different settings for the illustrative examples in FIGS. 9A-9B and 10A-B.

TABLE 1.1
Diffusion Film Settings for two diffusion screens: 12 iterations

| | DFS1 (4 settings, HD′ | |
|---|---|---|
| DFS1 (3 settings, HD, | (HD > HD), LD′ (LD′ > | |
| LD, None) | LD), Fourier 1′, None) | Result in field |
| HD | None | HD, no eye safety |
| LD | None | LD, no eye safety |
| None | None | Clear illumination |
| | | from Collimator, |
| HD | HD′ | High Dispersion <HD |
| | | (see US Pub. 2006- |
| | | 98243), |
| HD | LD′ | Medium Dispersion |
| LD | HD′ | Medium Dispersion |
| LD | LD′ | Narrow angle field. |
| HD | Fourier 1 (eye safety) | HD w/eye safety |
| LD | Fourier 1 (eye safety) | LD w/eye safety |
| None | Fourier 1 (eye safety) | Eye safety clear |
| | | illumination |
| None | HD′ | HD′ |
| None | LD′ | LD′ |

TABLE 1.2
Diffusion Film Setting for two diffusion screens: 16 iterations

| DFS2 (4 settings, | DFS1 (4 settings. HD′, | |
|---|---|---|
| HD, LD, Fourier 1) | LD′, Fourier 1′, None) | Result in field |
| HD | HD′ | High Dispersion <HD |
| | | (see US Pub. 2006- |
| | | 98243), |
| HD | LD′ | Low Dispersion <LD |
| HD | F1′ | HD with eye safety |
| HD | None | HD |
| LD | HD′ | Medium Dispersion |
| LD | LD′ | Narrow angle illumination |
| LD | F1′ | LD with eye safety |
| LD | None | LD without eye safety |
| F1 | HD′ | HD′ with eye safety |
| F1 | LD′ | LD′ with eye safety |
| F1 | F1′ | Eye safety with potential |
| | | additional Fourier features |
| | | (secondary and/or eye |
| | | safety). |
| F1 | None | Eye safety only |
| None | HD′ | HD′ |
| None | LD′ | LD′ |
| None | F1′ | Secondary features |
| | | and/or eye safety |
| None | None | Clear illumination from |
| | | collimated radiation |

Referring now to FIG. 10C, a sample of the radiation field effect as generated by two diffusion screens DFS1 and DFS2. In the illustration, E1 passes through two different diffusion films, each with a different diffusion angle creating dispersion angles alpha 1 and alpha 2. E2 passes through dispersion angles alpha 3 and alpha 4. Some of these principles of the multi-angle dispersion films, are discussed in more detail in US Patent Publication 06-98423 (May 11, 2006), which is incorporated by reference for all purposes.

In some embodiments of the multiple diffusion plates, multiple laser diodes are used as discussed above in FIGS. 7A-D to similar effects. In addition, the laser diodes in the embodiments discussed in FIGS. 7A-10C may pulse at different times, providing a continuous stream of light to the collimator lens, or they may be activated together to provided an enhanced beam of light to the collimator lens with these features. The laser diodes may all be of the same wavelength or they may have different wavelengths.

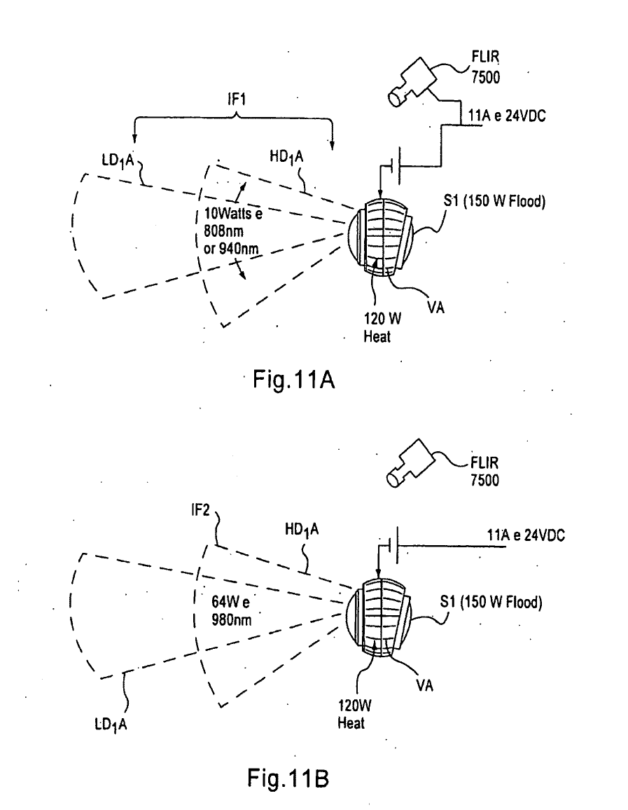

FIGS. 11A and B are illustrative of sample results in an exemplary test of an embodiment of the invention in the form of an aircraft landing illuminator, the following specifications were tested:

[symbol]

Power: 11 amps @ 24 VDC; [symbol]
Heat produced: 120 watts of heat; [symbol]
Mass (embodiment of die cast aluminum housing): 3 lbs (appx. 1.4 kg) [symbol]
Life 5000 hours @ max power with 64 watts of output radiation.

In general the performance for an exemplary embodiment of the aircraft landing/vision embodiment of the invention, as tested for 808 nm was roughly half of the 808 nm at 940 nm and one-quarter at 980 nm. The tested models of an embodiment of the invention were provided with 10 watts of 808 nm and/or 940 nm (FIG. 11A), and 980 nm up to 64 watts (FIG. 11B).

The model of an embodiment as tested served to enhance the vision capabilities of existing vision equipment. The model of an embodiment of the invention as tested was tested in OH-58 helicopters (see FIGS. 4A-C) used by a state National Guard, the helicopters were generally equipped with the following for airborne viewings: 1) large multi-million cp spot light in visible wavelengths; 2) FLIR 7500 or 8500 thermal/low light imaging systems; 3) standard equipment IR complement in the form of a 150 watt light bulb with IR filter, see SI, FIGS. 3A-3C) to the nose landing light, which provided about 20 feet of illumination (6.1 m); 4) Gen IV NVG. The results generally show that significant improvement occurred for the FLIR 7500 low light camera systems and the NVG employed.

Estimates of an embodiment of the invention in assisting the current aircraft vision equipment shown in FIGS. 4A-C, and listed above, include the following for 808 nm, using the FLIR low light sensor discussed above: 3500′ (appx. 1066 m) @ 20 degrees (see DF2, FDIA, FIGS. 1-2) and 5300′ (appx 1615.5 m) @ 5 degree (see DF1, LDIA FIGS. 1-2); for the NVG: 5300′ (appx. 1615.5 m) @ 20 degrees (see DF2, FDIA, FIGS. 1-2) and 7300′ (appx 2225 m) @ 5 degree (see DF1, LDIA FIGS. 1-2). These estimates are illustrated in FIGS. 12A and 12B, respectively.

The laser illuminator of certain aircraft embodiments of the invention was tested in an effort to modify and improve existing equipment on the OH-58 and FLIR to enhance or supplement night vision capability. The illuminator used in a test of an embodiment of the invention was equivalent in output to what should be produced and installed on the helicopters on which it was tested and other helicopters in the fleet. The NVG's were tested without any illumination from an embodiment of the present invention and no other artificial light. When an embodiment of the present invention was added, there was a substantial difference of what could be seen with the NVG's. With illumination from an embodiment of the present invention, human subjects were able to see through vehicle glass and along side buildings. Thus, embodiments of the invention in combination with these NVGs are extremely helpful on some of the missions to see through glass. Also, by using the illuminator and low light camera instead of the thermal imager people are more recognizable. The laser illuminator increased vision much more than the IR light that is currently available.

Next, the laser illuminator in an embodiment of the invention was tested with the FLIR low light and infrared cameras. It was found that the illuminator greatly enhanced the picture with the low light camera. As expected, it had no effect on the thermal imager.

The long-range laser illuminator in an embodiment of the present invention, as configured for use with NVG's and low light camera work was found to be highly beneficial. Ideally, for use with the NVG's, the light would be capable of pointing up, down, and sideways like the current IR light does. If an illuminating system was installed in the existing housing, and the controls are already in place (see FIGS. 4A-C). Additionally, the laser illuminator would draw less power and produce less heat than existing systems. For using the illuminator with the low light camera on the FLIR, it would be best to have the illuminator point where the camera does. The illuminator of this embodiment of the invention should be generally installed on the FLIR ball so the light beam points where the camera does, or have the illuminator slaved to the FLIR. It would also be helpful if the beam width of the illuminator was variable. A narrow beam is more useful for farther distances, and a wider beam is better for closer targets. The beam should generally be adjustable from 4 degrees to 20 degrees.

Referring to FIGS. 13-17, two configurations of the improved optical component of collimator as may be used in the various embodiments of the long-range illuminators. Referring to FIG. 13, a typical distribution of the intensity of planar light emitting from a collimator lens CL(1) or CL(2) from FIGS. 1-2 et seq. is shown. This is a front on view of an embodiment of a collimator lens CL(1) or CL(2) showing that although the planar light is described above as substantially evenly distributed, areas of intensity are often still present. The planar light will be more intense towards the base of the collimator lens, with a gradual decrease in intensity moving up the lens. Although the intensity change is not abrupt, it does tend to resemble a Gaussian curve 5, or a double Gaussian curve if two light sources are being used.

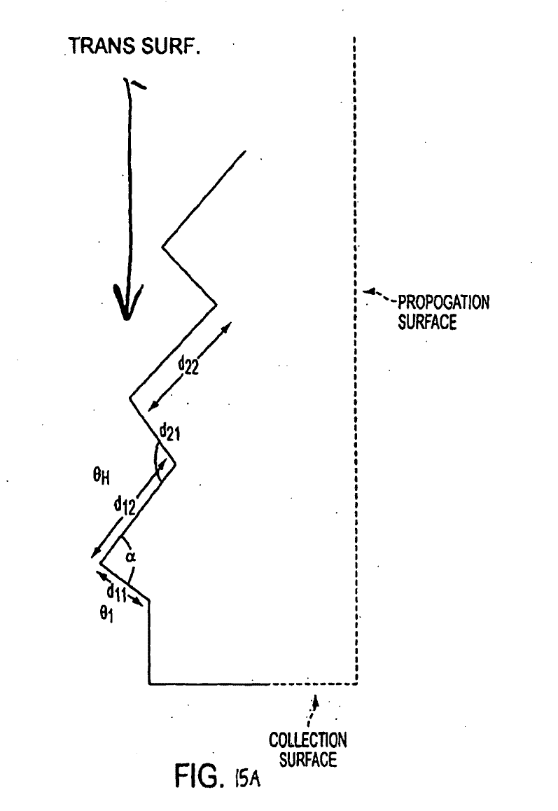

Referring now to FIG. 14A, a first embodiment of a compound component plastic-mold injected collimator is shown from ¾ front-to-side angle. A two piece system is illustrated in which the lens LS is manufactured apart from the installation apparatus IA, which may be thermally or chemically welded on-site or at other locations. In alternate embodiments, any installation apparatus may be directly incorporated into the mold-injection system or made out of a different material, if necessary at all.

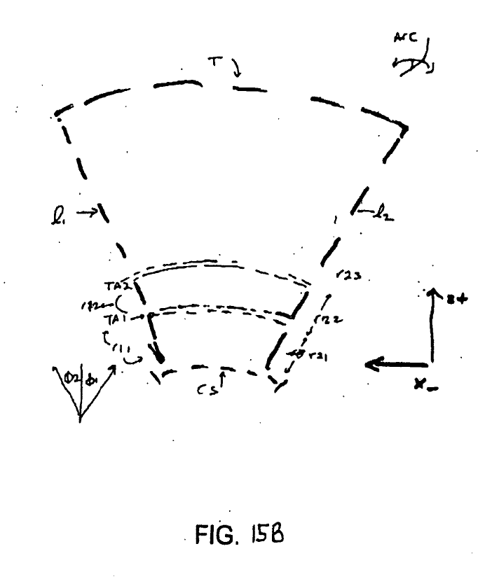

FIG. 15A illustrates a sample of a collimator used in the invention in a first embodiment in which the cutaway view of the improved collimation system is shown. Light or other types of radiation (coherent or divergent) is “collected” at the collection surface (marked) and passed through a series of reflection/transmission areas which comprise the transmission surface (marked) and passes out the projection surface (marked). The transmission surface includes a series of transmission areas each of which include a protrusion section (shown as d11) at angle Θ1 out from the direction of the radiation which then turns “inward” (towards the projection surface) at angle ω1 and a reflection surface d12, which protrudes into the interior, past the point (p(i1)) at which (in the y-direction) d11 started to move “outward.”

Additional transmission areas are configured along the transmission surface moving in the y+ direction towards the “top” T of the collimator. The transmission areas are marked as a combination of the two (or more in alternate embodiments) “sides” (d21)+(d22) and angles θ2, ω2, increasing by index number in the z+ or “upward” direction (e.g. d31, d32, Θ3, ω3, etc.). As can be appreciated by those skilled in the art, the transmission surface does not need to be entirely comprised of transmission areas, but can be configured to maximize transmission to the propagation surface PS as shown in the drawings.

FIG. 15B is a “front” view of the transmission surface TS. Successive transmission areas ta1, ta2, . . . , are shown running in an horizontal arc (in the x+/−direction, which also rise and fall in the z+/−direction as well) along the length (L1 and L2) of the collimator lens to the top T which also may be configured in an arc. The angles respectively formed by each side (L1, L2) and the z-axis are shown by angles Φ1 in the x+ direction and Φ2 in the x− direction. In the shown embodiment, the two angles and sides are respectively the same, but do not need to be. The distance between each transmission zone ta1, ta2, . . . is shown as r11, r12, . . . along side I1 and r21, r22, . . . along side 12. The collection surface CS is discussed in U.S. Pat. No. 6,422,713, which is incorporated by reference and will not be discussed further for the sake of economy.

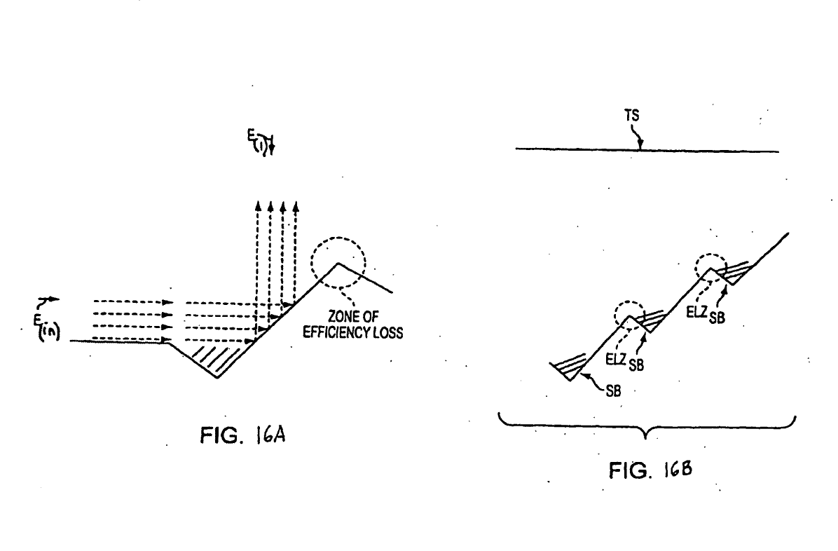

Referring now to FIG. 16A, a diagram of the electromagnetic energy transmission in the improved lens is shown. Electromagnetic energy, generally in the form of infrared light and shown by the dashed arrows and marked as the Electromagnetic radiation field E-(init), moves along the z-axis in the positive direction. In most embodiments, the (incident) light will enter the collimator at the collection surface CS, discussed above and be reflected towards the propagation surface. Although the light energy in E-(init) will be lost at the single zone of efficiency loss (marked), and have the energy now in the transmitted E-(1) field, the recessed portion SB will prevent the light energy from loss at more than one transition point per transition area. Efficiency loss in these zones is generally due to several factors, some from optical transmission limits, but generally, some efficiency loss is related to limitations in the manufacturing and finishing process(es) of materials are economical enough to make the end-use device economically practical.

The improved transmission surface is apparent in FIG. 16B in which it is seen how many zones of efficiency loss ELZ are eliminated along multiple transmission areas and replaced with the recessed portions SB which also protect the transmission surface TS, during the manufacturing and finishing process (see below.)

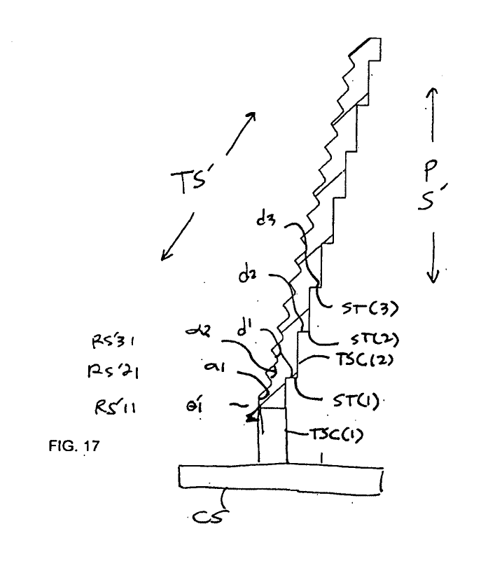

FIG. 17 illustrates a second or alternate configuration of the inventive collimator as may be implemented in various embodiments of the present invention, which requires even less high-quality acrylic material than the first embodiment. In the alternate embodiment, the propagation surface PS′ is cut in a staggered pattern, such that the light/electromagnetic energy will eventually emanate from different y-axis locations (back to front) along the Z-axis (bottom to top), which are shown as each propagation surfaces TSC(1), TSC(2) . . . TSC(n) (which is located at the top of the collimator). The distance between the “staggers” for the vertically-staggered propagation surfaces TSC(1), TSC(2) . . . TSC(n), is shown in the staggered collection surfaces ST(1), ST(2) . . . , ST(n) which are perpendicular to the staggered propagation surfaces along the y-axis, and is shown as distance d1, for the y axis distance from surface ST(1) to ST(2), d2 for the y-axis distance from surface ST(2) to ST(3), etc. Although the “stagger” distances d1, d2 . . . dn, are shown as similar, there is not any particular limitation that requires that the distances be uniform if the end use of the collimator requires a different configuration. In the alternate embodiment, the transmission surface TS′ operates on much of the same principle as recited above for the collimators discussed above in FIGS. 14-16B, includes a series of transmission areas or reflection surfaces RS′(1), RS′(2) . . . RS′(n), each of which include a protrusion section (shown as d′11) at angle Θ′1 “out” from the y-direction of the radiation which then turns “inward” (towards the propagation surface PS′) at angle ω′1 and a reflection surface d′12, which protrudes into the “interior” of the collimator where the electromagnetic energy is traveling in the z-direction. The optical source travels “up” the z-axis in the optical collector through the clear acrylic to the reflection surfaces RS(1) . . . RS(n), that are positioned at angles similar to those detailed in the first embodiment described above, which allow the reflection surfaces RS(1) . . . RS(n) to be polished/brushed in an economical manner that does not degrade the reflection properties of the transmission surface S′ because of the improved configuration.

Referring again to FIG. 17, it be understood as illustrating an additional advantage of the second collimator configuration, such that the staggered underside surfaces ST(1) . . . ST(n) to act as “collection surfaces,” because the electromagnetic energy E(source) passes though the base collection surface BCS, running parallel to the staggered propagation surface PS′ and entering the respective underside collection surfaces. Although a very small amount of electromagnetic energy may be lost because of the transmission efficiency of the high-quality acrylic, the optical energy is “entering” the secondary surfaces ST(1), ST(2) . . . ST(n), which perpendicular to the direction of the energy, and therefore the amount of lost energy lost is balanced out by the cost savings of high-quality material. Additionally, the reduced weight and footprint of the improved collimator also balances out the minor loss of energy that is lost by the light passing through two collection surfaces.

In many embodiments of the invention, the casing of the light diffuser is made with a rigid, thermally conducting (although) light materials, such as, but not limited to, aluminum. The purpose of the casing is two fold. It provides protection to the instruments within and it diffuses heat. Although the collimator lens can be themselves made with a variety of materials, ranging from very fragile to relatively non-fragile, it is still preferred that they not be exposed to impact damage. The surfaces of the collimator lens and mirrors further need to be kept as clean and clear as possible, so the casing should be air tight, and in some embodiments filled with gasses that do not scatter the projected light. To aid in the diffusion of heat, the casing has a plurality of fins that further aid in the diffusion of heat without adding significant weight.

The heat produced from the laser diode can further be dissipated in a number of different ways. One such way is to place the diode on a heat sink, such as a copper block, which may include up to 100 percent copper (which is preferable not machined directly). Although heat sinks will increase the weight of the light diffuser unit, there is a trade off between weight and heat diffusion. This trade off is also dependent on the use of the light diffuser unit. Hand-held models will optimally include a heat sink, while those mounted on machinery could do without. The addition of a heat sink also limits the infrared light pollution that might otherwise contaminate the projected light in some applications. The laser diodes may also be mounted on, or used with heat dissipating or cooling ceramics or thermoelectric coolers, such as the DT and AT series from Marlow Industries of Dallas, Tex. The specifications of these cooling or heat pumping ceramics are included herein for the purposes of implementing certain embodiments, in terms of both appropriate use and installation of such ceramics of the invention that require such a level of heat sinking and these ceramics may be included alone or in combination with the other heat sinking methods discussed herein.

The heat sink itself might have an interface between itself and/or the diode and the casing. For example, indium foil can be placed between the diode and a copper block to improve dissipation. Also, other materials such as Wakefield Thermal Compound heat conductive grease can be used between the heat sink and the casing. Fans, both internal and external can also be used. An internal fan would optimally blow on or near the laser diode, while an external fan would supply air to the internal space. In addition, thermal electric coolers or TE coolers can be used to move heat from the heat sink to the external housing for greater heat transfer.

In alternate embodiments, to make a light diffusion unit effective, the light emitted from the laser diodes needs to travel a certain distance to the collimator before contacting the collimator lens. By reflecting the light in a mirror (not shown), the light is able to travel the required distance, but the space required in the light diffusion unit is essentially halved. This allows for the size of the light diffusing unit to be greatly reduced. As an example only, the light from the diode travels approximately a few inches to the mirror and then a short distance to the collimator lens. The use of a mirror in this manner will reduce the overall efficiency by approximately 1% to 5% or even less depending on the quality of the mirror. In other embodiments, other components that reduce efficiency but improve the system as a whole may also be used. For example, putting a protective lens for the illumination cover IC, such as a glass or acrylic lens, over the end of the unit may reduce efficiency by about 2-5%, but will provide protection for the diffusion screens and internal components, and may be part of the end-user needs, such as manufacturing costs (plastic mold injection, snap-on, etc.). Although most of the embodiments of the invention require a one or more separate diffusion screen with multiple types of diffusion films, a plastic-mold injection system that can incorporate the holographic diffuser screen HDS because of its polycarbonate properties with a tough acrylic lens that can snap into the rigid body is particularly efficient for cost reduction and reduced manufacturing error.

Certain configurations and embodiments of the invention have been discussed above, however, the spirit and scope of the invention is beyond that of the examples which have been provided for illustrative purposes only. Rather the scope of the invention should be defined by the following claims.

1. An illumination system, comprising:
a power source operatively coupled to at least one diode capable of producing radiation;
a collimator for direction said radiation from said laser toward said translucent film;
a plate made from a translucent material, said plate having at least two types of diffusion films disposed thereon, located independently of each other;
a housing unit with an at least portion that is a translucent cover;
wherein said radiation passes through collimator, such that said radiation is dispersed through said translucent material to said at least two types of diffusion film and out of said translucent cover.

2. The illumination system as recited in claim 1, wherein said rotating plate is circular.

3. The illumination system as recited in claim 1, wherein said first type of said at least two types of diffusion film causes said radiation to be dispersed at a low dispersion angle when it is passed through it.

4. The illumination system as recited in claim 3, wherein said second type of said at least two types of diffusion film causes said radiation to be dispersed an angle greater than said low dispersion angle.

5. The illumination system as recited in claim 1, wherein said plate is divided into quadrants, wherein two of said quadrants do not include any of said at least two types of diffusion film.

6. The illumination system as recited in claim 1, wherein said at least one laser diode is mounted on heating sinking means.

7. An illumination system comprising:
a first laser diode and a second laser diode coupled with a power source;
a first optical collimator and a second collimator, configured such that said first collimator collects radiation from said first diode, and said second collimator collects radiation from said second diode;
said first and second collimators directing said first and second radiation from said first and second diodes towards a translucent plate;
said translucent plate including at least two type of diffusion films;
wherein said directed first radiation passes through a first type of diffusion film of said at least two types of diffusion films; and said directed second radiation passes through a second type of diffusion film of said at least types of diffusion film;
a cover, including a clear section so that said first and second type of diffused radiation passes through said clear section.

8. The illumination system as recited in claim 7, wherein said first and second laser diodes generate respectively different wavelengths of radiation.

9. The illumination system as recited in claim 7, further including an actuator, wherein said translucent plate is rotated by said actuator.

10. The illumination system as recited in claim 7, further including a second illumination source in the form of a flood light, said flood light positioned opposite to the direction of said radiation.

11. An illumination system comprising:
a rotating plate made of a translucent material; said rotating plate attached to an adjustable rotating actuator;
said rotating plate including a first type of diffusion film and a second type of diffusion film;
said first type of diffusion film causing radiation that passes through it to be dispersed at a first angle between 1 and 10 degrees;
said second type of diffusion film causing radiation that passes through it to be dispersed at a second angle between 11 and 25 degrees;
at least one laser diode connected to a power source, and an optical element, wherein said at least one laser diode creates said radiation and directs said radiation through said optical element, said optical element directing said radiation towards said rotating plate.

12. The illumination system as recited in claim 11, wherein said rotating actuator may be controlled to adjust the speed of said rotation.

13. The illumination system as recited in claim 11, further comprised a low-light camera.

14. The illumination system as recited in claim 11, further including a housing for including said at least one laser diode, said rotating plate and said optical element, wherein said housing is configured to include a translucent section for dispersing said radiation, and ventilation cuts in an area separate from said translucent section.

15. The illumination system as recited in claim 14, wherein said housing is made of die-cast aluminum.

16. The illumination system as recited in claim 14, wherein said housing is made of two parts.

17. The illumination system as recited in claim 11, wherein said power source is provide externally to said illumination system and is between 1-20 amps.

18. The illumination system as recited in claim 11, wherein said power from said radiation propagated from said rotating plate is between 10 and 70 watts.

19. The illumination system as recited in claim 11, wherein said at least one laser diode includes at least two laser diodes that produce radiation of different wavelengths.

20. The illumination system as recited in claim 11, further including a flood light, approximate opposite to a direction of said radiation from said films.

21-37. (canceled)
